(19) United States
(12) Patent Application Publication
(10) Pub. No.: US 2002/0026578 A1
(43) Pub. Date: Feb. 28, 2002

(54) Secure usage of digital certificates and related keys on a security token

(75) Inventors: Ernst-Michael Hamann, Boeblingen (DE); Robert Sulzmann, Holzgerlingen (DE)

Correspondence Address: Jeanine S. Ray-Yarletts, IBM Corporation, T81/503, PO Box 12195, Research Triangle Park, NC, 27709, US

(73) Assignee: International Business Machines Corporation, Amonk, NY (US)

(21) Appl. No.: 09/918,742

(22) Filed: Jul. 31, 2001

(30) Foreign Application Priority Data
Aug. 22, 2000 (EP) 00117995.1

(51) Int. Cl. H04L 9/00

(52) U.S. Cl. 713/159

(57) ABSTRACT

The present invention relates to a security token and method for secure usage of digital certificates and related keys on a security token, and more particularly, a secure import of certificates into a security token and their secure usage by applications. The root certificate of the certification authority(CA) is used during the initialization of the security token in a secure environment to transfer the certified root public key of the CA and its attributes into the data structure of the security token. The public root key is write protected. Furthermore, a verification component, preferably part of the operating system of the security token will accept, incase the certificate has to be replaced, only user certificates having a valid digital signature by the private root key of the CA.

### BACKGROUND OF THE INVENTION

The present invention relates to a security token and method for secure usage of digital certificates and related keys on a security token, and more particularly, to a secure import of certificates into a security token and their secure usage by applications.

If a customer orders some goods or services, he often has to sign a contract on paper to testify that he placed the order and is liable to pay for it. If the customer makes the deal over an electronic network instead, he needs the electronic equivalent of signing a paper: digital signature. Such a digital signature must guarantee that a customer cannot repudiate his order.

The different methods for digital signature are based on an asymmetrical key pair. The signing person has a private key which cannot be accessed or used by anybody else. A second key, which is associated to the private key, is known to the public. This key is called public key. Only the unique owner of the private key can sign an order, while everybody can check the signature using the corresponding public key.

The public key is distributed in a certificate, which contains owner's name and public key and some further information. In addition, the certificate has an expiration date. A reasonable question is, “how do we know that the public key in the certificate is not manipulated?” The answer is that a trusted authority digitally signed the certificate. To check the certificate signature the public key of the signer is needed, which is in the certificate of the signer. This certificate is signed by a trusted authority. The recursion can go on until we arrive at the root certificate, which is something that we trust because it was distributed through a trusted channel, for example shipped with the web server.

The most secure place to store such a private key is a security token. A security token is a data processing system which is portable and usable in connection with another data processing sytem or integrated into another data processing system comprising at least a RAM, a ROM, a EEPROM and a microprocessor including specialized functions for accomplishing secure crytographical methods. A smartcard can be considered as the most convenient and most portable security token geven the current state of the technology. Modern smart cards are able to perform the signing operation inside the card. At the same time they do not provide any function to export the private key to the outside.

During the import of certificates to a security token (e.g smart card), the validity of a certificate cannot be checked on the security token. This may create errors during the storage of the certificate objects and afterwards during the usage of such stored erroneous certificate on the token. The usage of key and certificate objects stored in the token cannot be guarantied without a valid root certificate of the certification authority (CA) which generated the user certificate. The root certificate may only be retrieved from an external database. For example, the user has to search and to retrieve the correct root certificate from an externally available central trusted location (such as an LDAP directory) and after verification of this certificate, extract the public key of the root certificate. This is a very time consuming process.

Furthermore, the external database will prohibit the secure use of the related keys stored on the token for off-line operations.

The user certificate will not be securely stored on a token and thus cannot be trusted by applications using a token for signature generation and verification. The validity of certificates stored on a token cannot be verified completely off-line.

U.S. Pat. No. 5,680,458 deals with a method of replacing a private root key when the private root key has been compromised and the recipient of a signed document can no longer be sure that the document was signed by the certifying authority and not by a party which compromised the private key. There is no teaching or suggestion in this patent how a user certificate may be securely stored, used or replaced by security tokens.

### OBJECTS OF THE INVENTION

It is therefore object of the present invention to provide improved protection of digital certificates and related keys on a security token.

It is further object of the present invention to provide a secure import of user certificates into a security token.

Finally, it is further object of the present invention to provide a secure verification of the user certificate stored on a token.

These objects are solved by the features of the independent claims.

Preferred embodiments of the present invention are laid down in the dependent claims.

### SUMMARY OF THE INVENTION

The present invention relates to a system and method for secure usage of digital certificates and related keys on a security token, and more particularly, a secure import of certificates into a security token and their secure usage by applications.

The root certificate of the certification authority(CA) is used during the initialization of the security token in a secure environment to transfer the certified public root key of the CA and its attributes into the data structure of the security token. The public rootkey is being write protected. Furthermore, a verification component preferably part of the operating system of the security token will accept afterwards, in a case the certificate has to be replaced, only user certificates having a valid digital signature by the private root key of the CA.

Any application using the user certificates and its related user private keys on the token is able to verify the user certificate using this secure public root key of the CA stored on the token. Preferably, the verification of the user certificate is then even possible during the off-line operation by using the extracted trusted public key of the CA stored on the token.

### BRIEF DESCRIPTION OF THE DRAWINGS

The present invention will be described in more detail using preferred embodiments with Figures, where

FIG. 1 shows structure and components of a smart card which may be used as a security token

FIG. 2 shows the content of the EEPROM after initialization of the smartcard according to the present invention

FIG. 3 shows a flow chart for verification of a new user certificate on the smart card according to the present invention

FIG. 4 shows a flow chart for creating a signature using the present invention.

### DETAILED DESCRIPTION OF THE PREFERRED EMBODIMENT

A security token may be used in connection with any portable data processing device, e.g personal digital assistant or mobile phone. The present invention will be described in detail on a smart card which may be used a preferred embodiment.

The chip(l0) of the smart card (FIG. 1)used by the present embodiment consists of a microprocessor(12), ROM(Read Only Memory; 18), EEPROM(Electrical Erasable Programmable Read Only Memory;16) and RAM(Random Access Memory;14). Today, most smartcards have an 8-bit microprocessor and in the high end cards there are 16-bit or 32-bit processor available.

A cryptographical processor as used by the present invention is needed for performing signature operations on the card itself. The user's private key never needs to leave the smart card.

The information stored in the ROM(18) is written during chip manufacturing. It contains the operating system and security algorithms (e.g. DES, RSA).

The EEPROM(16) is used for permanent storage of data and is used as storage of user certificates, public key of the CA and root certificate of the CA as well as routines for accomplishing the present invention,e.g verification of user certificates. This information will be written into the EEPROM(16) during initialization of the smart card preferably. The PAM(14) is the transient memory of the smart card and keeps the data only as long as the card is powered.

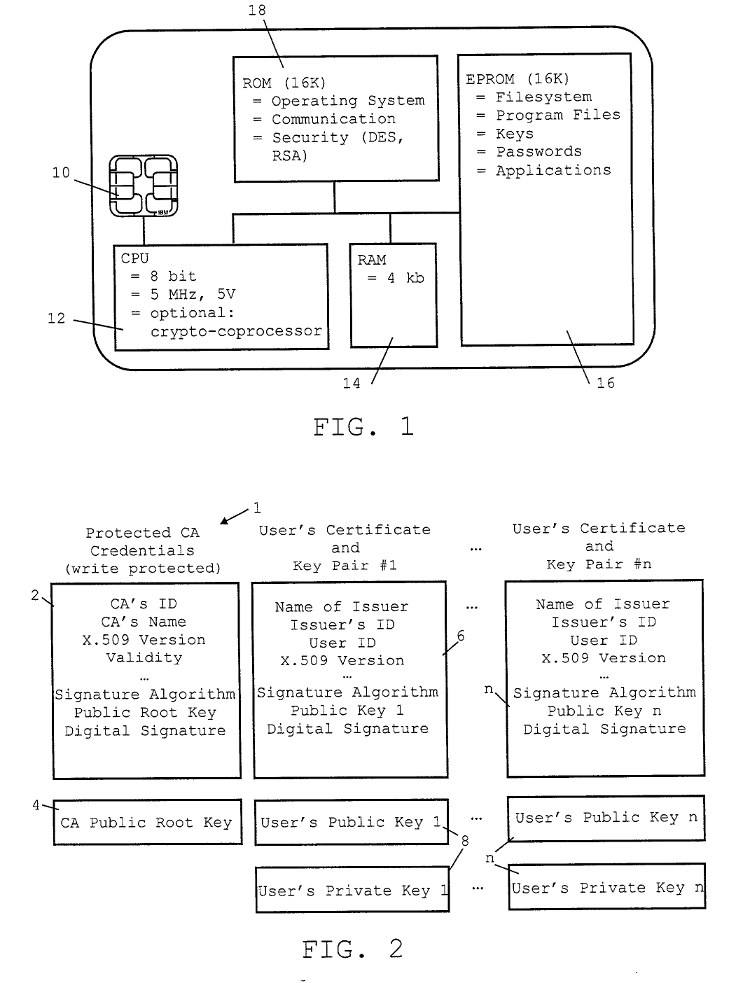

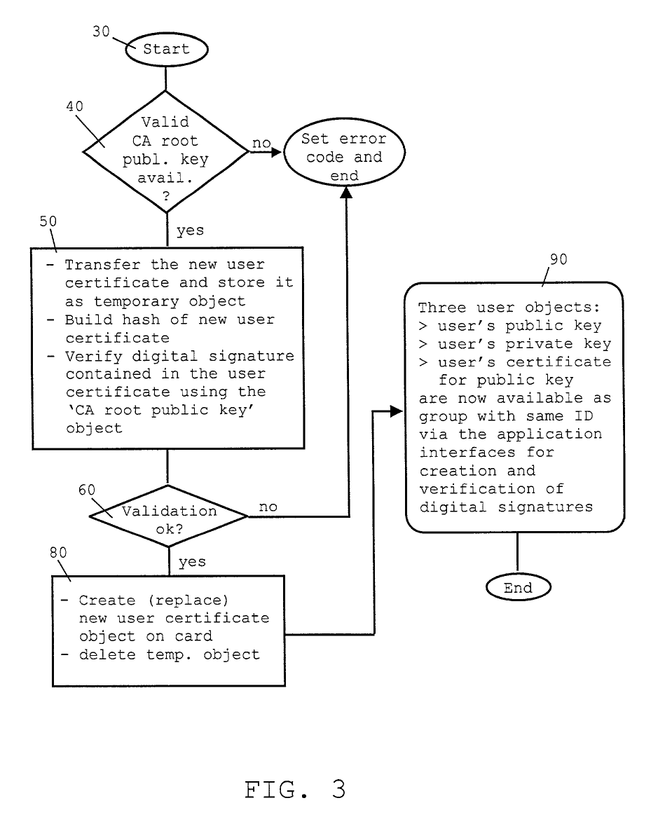

FIG. 2 shows the content of an EEPROM (1) of a smart card presented to carry out the preferred embodiment of the present invention. At manufacturing time especially during personalization or initialization of the smart card, the root certificate(2) of the certificate authority (CA) and the public root key(4) of the CA extracted from the root certificate(2) are securely stored as objects in the EEPROM(1). Both objects(2, 4) are stored via an access condition so that they cannot be replaced or deleted by unauthorized operations after the smart card has been issued. The validity dates contained in the root certificate(2) are used to limit the usage of the smart card and the user's key and certificates. There may be several key pairs and related certificates of one or many user stored on the smart card. The maximum number of key pairs(n) to be stored in the EEPROM(1) are defined during creation (e.g personalization) of the smart card.

The object user public key (8) may be stored additionally in the EEPROM of the smart card allowing applications to obtain the public keys of the user faster instead extracting them from the user certificates. This applies accordingly for the public root key (4) which may be stored additionally in the smart card.

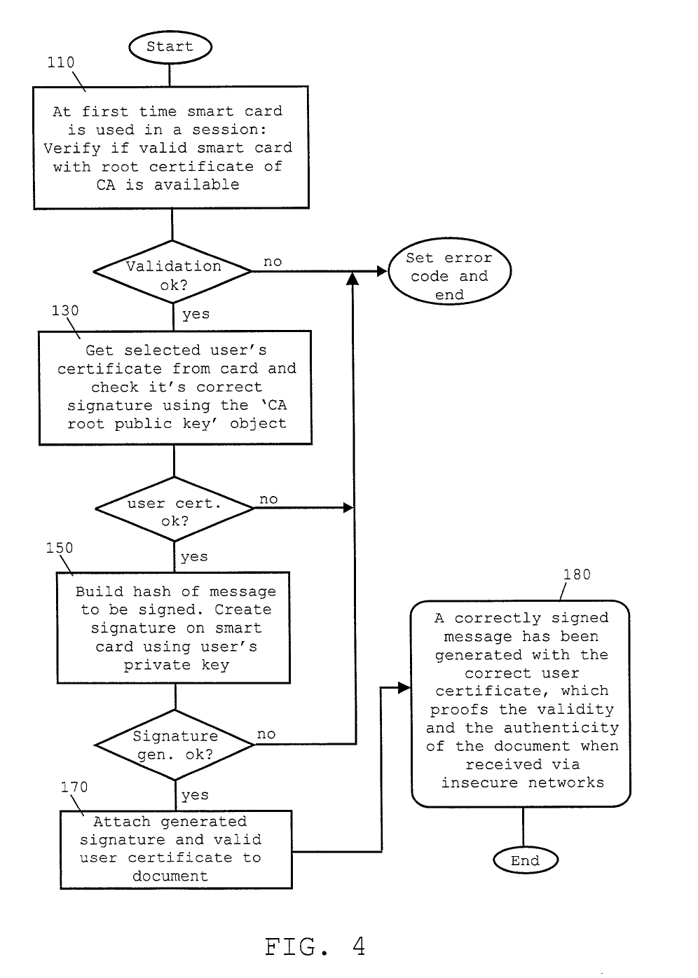

FIG. 3 shows the single steps of the verification routine which may be part of the smart card's operating system or may be a separate component called by the operating system or other functions.

A new user key pair (e.g RSA public and private key) may be securely generated on the smart card. When the certificate is requested at the CA by the user for one of his public keys, this is done together with the Root Certificate of the CA stored on the smart card. After the CA has tested the information provided by the user and the root certificate of the CA, the CA generates a new user certificate for a new public key.

The new user certificate is returned by the CA to the user's client system and is then stored on the smart card. The smart card operating system validates this new user certificate by checking the digital signature using the stored public root key of CA and the signature algorithm (e.g RSA, ECC, DSA). When the signature is valid, the new user certificate is valid.

The verification routine is called every time a new certificate object has to be stored on the card, especially during the initialization/personalization of the smart card with the user's certificates at card issuing time or during the storage of a replacement certificate at the user's or administrator's client system when e.g the original user certificate has expired. A new user certificate is only accepted by the smart card when the digital signature of the certificate provided with the certificate is successfully verified on the card using the public root key of the CA.

The verification routine comprises as least following steps:

1. Sending new certificate from the CA to a data processing system which communicates via a wired or wireless connection with a security token, e.g smartcard via(30)

2. Checking the availability of a public root key in the EEPROM of the smart card(40)

3. Storing the new certificate as a temporary object in the EEPROM of the smart card if a public root key is available(50)

4. Generating a HASH over the new user certificate temporarily stored in the smartcard (50)

5. Verifying the digital signature contained in the new user certificate and using the public root key stored in EEPROM for decrypting the digital signature(50)

6. Comparing the HASH generated by step 4 with the HASH generated by step 5 if both identical then the new certificate is authenticated (60)

7. Creating a new user certificate object on the smart card and deleting or validating the temporary user certificate (80)

8. Optionally, to improve the linking of the user public key, user private key, and user certificate for the public key these three objects are available as a group with same ID via the application interface for creation and verification of digital signatures.

The new user certificate consists of two parts. The first part, for example, contains data elements relating to the key, the issuer of the certificate, the user, the signature algorithm, the serial number, etc. The second part of the certificate contains a digital signature relating to the first part of the certificate. A digital signature basically establishes the authenticity of electronically transmitted messages or electronic documents. The process of generating a digital signature can be presented as follows.

From the first part of the certificate a HASH algorithm(e.g.SHA- 1, MD5) is used to form a HASH value. The HASH algorithm compresses the data from the first part of the certificate. Then the HASH value is decrypted with a crypto algorithm. Decryption is based on the private key of a key pair. In the present case the new certificate is encrypted with the private key of the CA.

FIG. 4 shows the communication between the smart card and an application installed on a data processing system using the present invention.

At a first time a communication is established between an application running on a data processing system and a smart card, the verification routine verifies the availability of the Root Certificate of a CA on the smart card (110). Then, the application obtains the certificate from the smart card, verifies the standard information stored in the certificate (e.g expiration date), retrieves the public root key from the certificate (110) and gets a selected user certificate from the smart card which will be used for creating a digital signature. Before that user certificate may be used, the verification routine verifies the digital signature contained in that user certificate, generates a HASH using the HASH algorithm specified in the user certificate and uses the public root key for decrypting the digital signature attached to the user certificate. If both HASHs are identical then the user certificate is authenticated (130).

Finally, a HASH is generated over the message to be signed, the HASH is encrypted with the private key and signature algorithm specified in the user certificate, resulting in a digital signature (150). The digital signature is attached to the message to be sent(170). A correctly signed message has been generated with the correct user certificate, which proves the validity and the authenticity of the message when received via an insecure network(180).

The present invention can also be embedded in a computer program product, which comprises all the features enabling the implementation of the methods described herein, and which—when loaded in a computer system—is able to carry out these methods.

1. A security token comprising:
a Random Access Memory (RAM),
an Electrical Erasable Programmable Read Only Memory (EEPROM),
one or more Microprocessors, and
a Read Only Memory,
and characterized in that said EEPROM having at least an object containing a user certificate and an object containing a certificate of the certification authority (CA) of said user certificate (root certificate), wherein said root certificate is being write protected, and a verification component for checking authentication of said user certificate using information of said root certificate:

2. A security Token according to claim 1, wherein said user certificate comprises at least following information:
a name of issuer,
an identfier (ID) of said issuer,
a user identifier (ID),
a HASH algorithm,
a signature algorithm,
a public key, and
a digital signature.

3. A security token according to claim 1, wherein said root certificate comprises at least following information:
a certification authority name,
a certification authority identification (ID),
a HASH algorithm,
a signature algorithm,
a public root key, and
a digital signature.

4. Security Token according to claim 1 comprising the following further objects in said EEPROM:
a public root key,
a user's public key, and
a user's private key.

5. A security token according to claim 1, wherein said verification component is part of the operating system of said security token.

6. A seurity token according to claim 1, wherein said security token is a smart card.

7. A method for initializing a security token comprising the following steps:
a) transferring a root certificate of a certification authority into said security token using a secure transmission environment,
b) securing the root certificate against modifications, and
c) storing a verification component into said security token allowing use or replacement of a user certificate only when said user certificate is authenticated by said root certificate.

8. A method according to claim 7, further comprising:
d) storing public root key additionally to said root certificate.

9. A method for authenticating information generated by an application using a security token according to claim 1 comprising the steps of:
a) retrieving a public root key from said root certificate,
b) generating a HASH over a user certificate using the HASH algorithm specified in said user certificate,
c) retrieving and decrypting a digital signature contained in said user certificate by applying said public root key resulting in a HASH of said user certificate, and
d) allowing use of said user certificate for signing said information with said digital signature when both HASHs are identical.

10. A method according to claim 9, wherein said information is a document or electronic mail.

11. A method according to claim 9, wherein said user certificate and said root certificate are sent to said application system and said steps a)-d) are accomplished on said application system.

12. A method according to claim 9, further comprising the step of:
checking the validity of the root certificate before retrieving said public root key.

13. A method for replacing a user certificate stored in a security token according to claim 1 comprising the steps of:
a) receiving a new user certificate from the certification authority and storing it into said EEPROM of said security token as a temporary object,
b) generating a HASH over a new user certificate using a HASH algorithm specified in said new user certificate,
c) retrieving a digital signature contained in said new user certificate and decrypting said digital signature by applying a public root key retrieved from a root certificate resulting in a HASH of said user certificate, and
d) permanently storing said new user certificate when both HASHs are identical.

14. Client-Server system having a client with a security token according to claims 1 to 6.

15. Data processing system using a security token according to claims 1 to 6.

16. Computer program product stored on a computer-readable media containing software for performing of the method according to claims 7 to 13.
